(19) United States
(12) Patent Application Publication
(10) Pub. No.: US 2026/0160285 A1
(43) Pub. Date: Jun. 11, 2026

(54) Fastener Clip Assembly with Threads for Receiving a Screw

(71) Applicant: Termax Company, Lake Zurich, IL (US)

(72) Inventors: Daniel James Dickinson, Lincolnshire, IL (US); David Friesorger, McHenry, IL (US)

(73) Assignee: Termax Company, Lake Zurich, IL (US)

(21) Appl. No.: 19/339,308

(22) Filed: Sep. 25, 2025

Related U.S. Application Data
(63) Continuation-in-part of application No. 18/518,506, filed on Nov. 23, 2023.
(60) Provisional application No. 63/432,644, filed on Dec. 14, 2022.

(51) Int. Cl. F16B 5/06; F16B 5/02

(52) U.S. Cl. CPC F16B 5/0642; F16B 5/0208

(57) ABSTRACT

A fastener clip assembly including a first wing and a second wing opposite the first wing. The first wing and the second wing are configured to couple the fastener clip assembly to a slot in a first component based at least on the first wing and the second wing being configured to generate a force against the slot in the first component. The fastener clip assembly also includes a screw and two or more platforms between the first wing and the second wing. The platforms include corresponding threads, with each of the threads being configured to receive the screw. The first wing and the second wing are configured to increase the force based at least on the screw being configured to push apart the first wing and the second wing based at least on the screw being configured to be threaded into the threads of the platforms.

### A. PRIORITY CLAIMS

This application claims the benefit of and is a continuation-in-part of:
U.S. patent application Ser. No. 18/518,506, filed on Nov. 23, 2023, titled “Fastener Clip Assembly with Multiple Threads for Receiving a Screw”, and naming Daniel James Dickinson and David Friesorger as inventors, which claims the benefit of:
U.S. provisional application no. 63/432,644, filed on Dec. 14, 2022, titled “Fastener Clip Assembly with Three Threads for Receiving a Screw ”, and naming Daniel James Dickinson and David Friesorger as inventors.

All the above-referenced patent applications are hereby incorporated by reference herein in their entirety.

### B. BACKGROUND

The invention relates generally to devices for fastening objects, and more particularly to a fastener clip assembly for insertion into an engagement structure, such as a vehicle chassis, a hollow substrate, a wall, a plate, or any suitable surface.

A number of devices and fasteners are currently available for fastening panels, such as body panels and automobile interior trim piece panels, to the chassis of a vehicle. As used herein, a body panel refers to, for example, any interior or exterior body panel on a vehicle, a plastic interior trim piece, door panel, headliner or any interior trim piece. Additionally, the panel may be any suitable exterior body panel, such as a fender, bumper, quarter panel or door panel. The chassis of the vehicle may include any substrate, plate, body panel, structural framework, chassis component or subcomponent, wall or any suitable object.

These conventional fastener devices provide approximately relatively equal levels of insertion and extraction force. These body panels often attach to the chassis of an automobile with a relatively high level of insertion force while providing a relatively low level of extraction force.

Fastener clips, such as two-piece fasteners (multi-piece), are known for attaching body panels to an automobile chassis. Two-piece fasteners are used so that if the panels are removed after original installation, such as to service the components in the door, they may be pulled apart so that one portion remains attached to the sheet metal while the other remains attached to the trim panel. The two pieces may also be reattached after separation. However, two-piece fasteners require manufacturing of multiple pieces and labor-intensive assembly of the two pieces and thus are relatively expensive.

One-piece fasteners are typically less expensive than two or multi piece fasteners. One-piece fasteners have a base to attach to a body panel and a post attached to the base and wings attached at least to the top of the post at a tip of the fastener for fastening to a frame slot. However, if the frame slot and the fastener are misaligned then the forces on the wings are unequal since the wing closest to the slot edge will experience higher wing compression while the other wing will have insufficient springing force to engage the slot. As the clip is forced into the slot, such high forces on one wing may cause the wing to break off thus rendering the fastener incapable of fastening the body panel to the frame. Worse, the broken, damaged or weakened wing can cause detachment of the body panel or contribute to rattles.

The wings of conventional fasteners have a sharp, unsmooth groove to engage the edge of the frame slot. When the clip is removed however, the sharp edges of the frame slot cut into the softer plastic and cut the groove. During manufacture, the slots are typically formed in the frame of the vehicle, such as in an inner roof or door sheet metal structure, by punching the sheet metal. As the punch enters the sheet metal, the outer part of the sheet metal is pushed toward the inside and a metal puncture or ridge is formed on the inside of the sheet metal. The resulting slot edge on the outer part of the slot is relatively smooth; however, the inner part of the slot edge is sharp and rough. Upon removal of the fastener clip, the sharp edges of the frame cut off the groove so that the clip may not be reinserted and reusable.

If the slot is off-center or if the sheet metal varies in thickness or if tolerances in production of the slot in the vehicle chassis or in the trim-piece exist, for example, then engagement of one portion of the hole in the chassis with one of the wings may not provide suitable frictional engagement. Twisting of the body panel will be likely more prevalent because less than all contact points are actually made with the slot of the vehicle chassis. As a result, conventional single piece fasteners do not self-align themselves when the fastener and the body panel are misaligned and are prone to wing breakage such that the fastener cannot be re-attached.

Conventional fasteners typically do not adequately secure the panel to the vehicle chassis having variations in slot size and location or sheet metal with different curvature or thicknesses throughout. Conventional single piece fasteners do not self-align themselves when the fastener and the body panel are misaligned and are prone to wing breakage such that the fastener cannot be re-attached. Also, conventional fasteners are not suitable when subjected to a variety of environmental conditions, such as in the presence of vibration at various levels of amplitude and frequency. For example, conventional fasteners of this type typically do not prevent or minimize the amount of buzzing, rattling or any other type of noise that may cause attention to the occupants of the vehicle or otherwise weaken the attachment. Conventional fasteners do not adequately accommodate various levels of production tolerances, such as various dimensions amongst, for example, the body panels as well as the vehicle chassis. Thus, conventional fastener devices typically do not self-align nor adequately fasten to a range of sheet metal thicknesses and do not minimize or eliminate buzzing and rattling and do not sufficiently accommodate variations in production tolerances. As a result, wear, squeaks, rattles, buzzing, corrosion and loss of elasticity and loss of sealing may result, especially after years of vehicle operation and exposure to vibration, heat, humidity, and other environmental conditions.

### C. BRIEF DESCRIPTION OF THE DRAWINGS

Other objects and advantages of the invention may become apparent upon reading the detailed description and upon reference to the accompanying drawings.

FIG. 1 is an exploded view of a fastener clip assembly, in accordance with some embodiments.

FIG. 2 is a view of a fastener clip, in accordance with some embodiments.

FIG. 3 is an alternative view of a fastener clip, in accordance with some embodiments.

FIG. 4 is another alternative view of a fastener clip, in accordance with some embodiments.

FIG. 5 is a view of an assembled fastener clip attached to a first component and to a screw and a second component, in accordance with some embodiments.

FIG. 6 is another view an assembled fastener clip attached to a first component and to a screw and a second component, in accordance with some embodiments.

FIG. 7 is yet another view an assembled fastener clip attached to a first component and to a screw and a second component, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### D. DETAILED DESCRIPTION

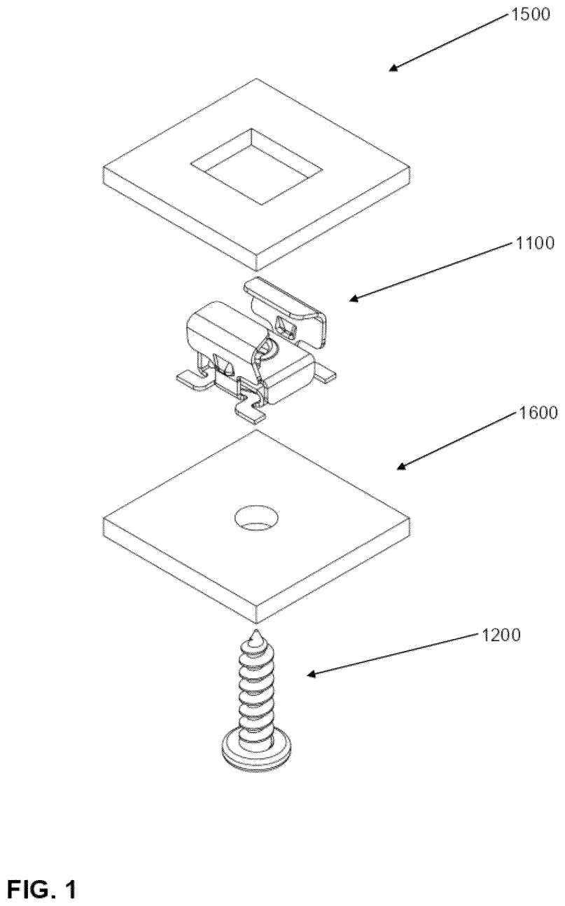

FIG. 1 is an exploded view of a fastener clip assembly, in accordance with some embodiments.

In some embodiments, the fastener clip assembly comprises high-retention fastener clip 1100 and screw 1200. Fastener clip 1100 and screw 1200 may be configured to fasten together two different components. For example, fastener clip 1100 and screw 1200 may be configured to retain various trim panels (such as second component 1600) to a vehicle chassis (such as first component 1500). It should be noted, however, that the fastener clip assembly may be configured to join various other pairs of components to each other and is not limited to fastening a panel to a chassis nor is it limited to vehicle applications.

Fastener clip 1100 may be configured to be inserted into and to attach to a slot/hole in first component 1500. Second component 1600 is configured to be attached to first component 1500 using a screw that is configured to be screwed into and attach to fastener clip 1100.

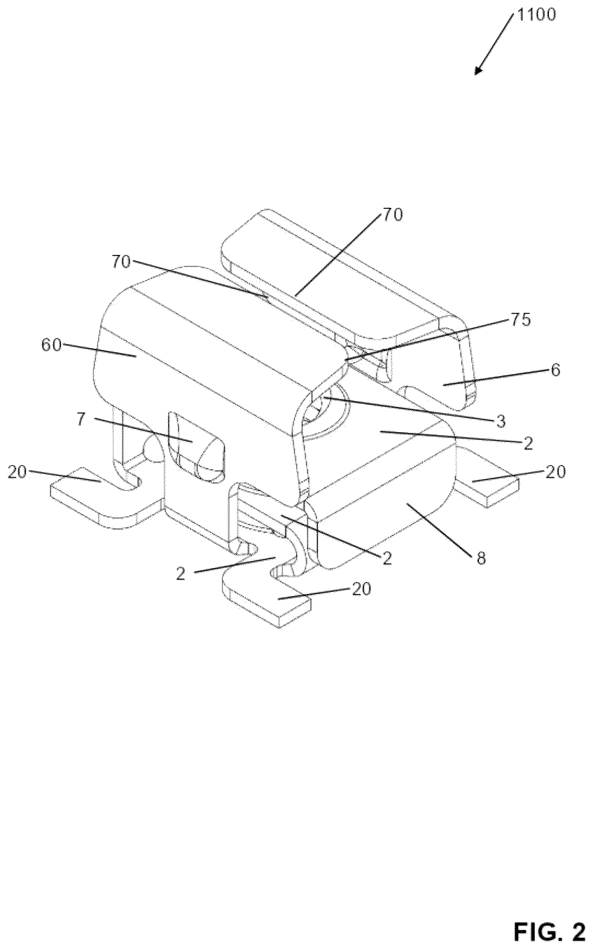

FIG. 2 is a view of a fastener clip, in accordance with some embodiments.

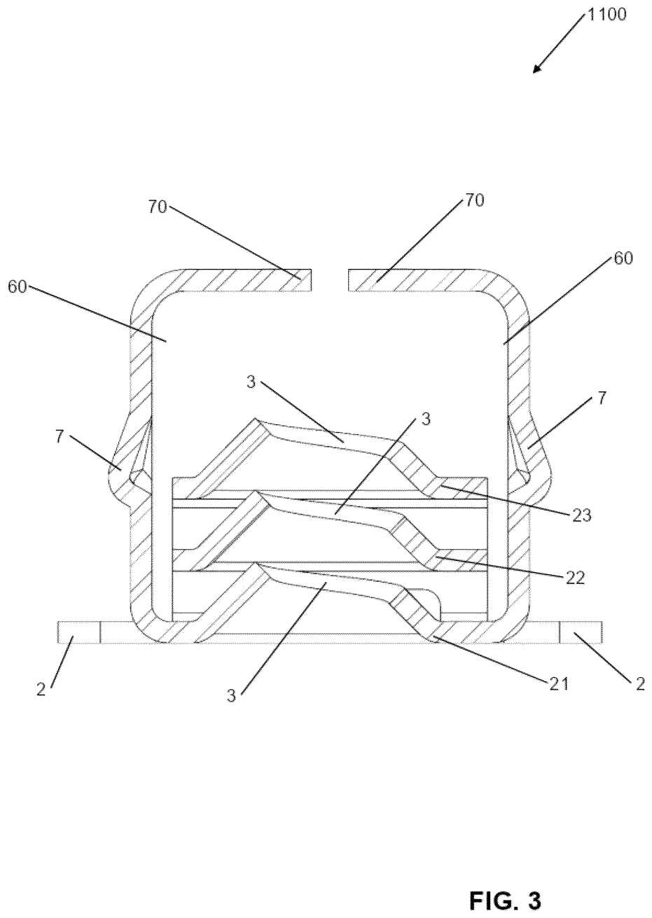

FIG. 3 is an alternative view of a fastener clip, in accordance with some embodiments.

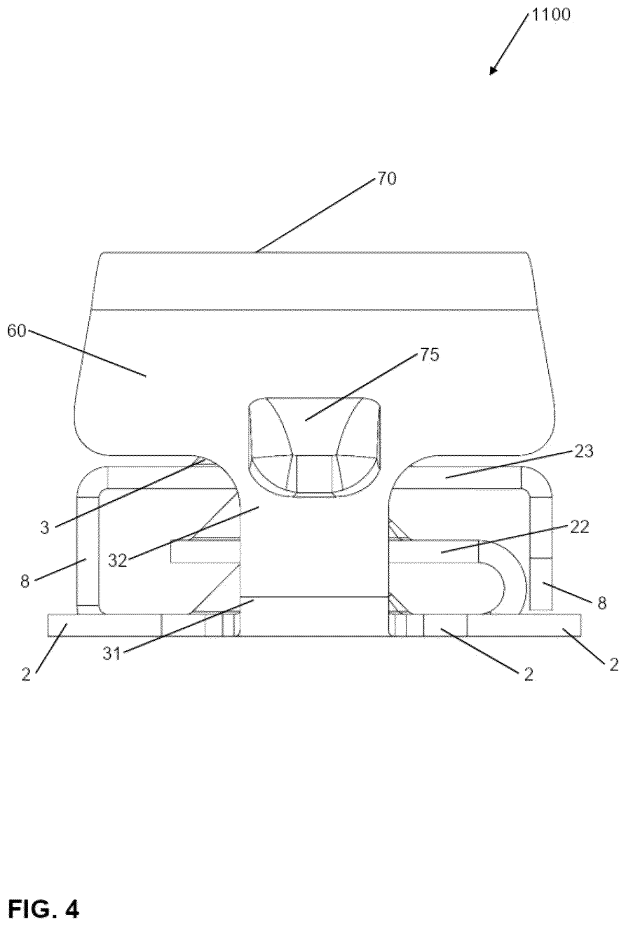

FIG. 4 is another alternative view of a fastener clip, in accordance with some

### EMBODIMENTS

In some embodiments, fastener clip 1100 comprises a pair of wings 60, one wing on each side of fastener clip 1100. A pair of head portions 70 extend approximately perpendicularly from pair of wings 60, each one of head portions 70 extending from each one of wings 60. In some embodiments, each of head portions 70 come substantially close to each other over the center of fastener clip 1100, having a small gap between them. In some embodiments, the gap between head portions 70 may be less than the diameter of screw 1200 as will be discussed below. It should be noted that the terms “pair” and “first and second” may be used interchangeably herein.

In some embodiments, fastener clip 1100 comprises a pair of bumps 75, one bump on each of wings 60. In some embodiments, bumps are configured to secure fastener clip 1100 to the slot in first component 1500. In some embodiments, pair of wings 60 (along with pair of bumps 75) are configured to bend inwards as fastener clip 1100 is being inserted into the slot in first component 1500 and then bend back outwards after pair of bumps 75 enters the slot. The bottom area of pair of bumps 75 is configured to engage the other side or inner portion of the slot, thereby facilitating a coupling between fastener clip 1100 and the slot of first component 1500.

In alternative embodiments, pair of bumps 75 may have other shapes. For example, pair of bumps 75 may be tabs that are attached to pair of wings 60 at a top of the taps only, with the tabs being free to bend inward and outward to facilitate a coupling between fastener clip 1100 and the slot of first component 1500.

In some embodiments, fastener clip 1100 comprises three parallel platforms 21, 22, and 23 stacked one on top of the other. In some embodiments, each of the platforms 21, 22, and 23 comprise respectively threads 31, 32, and 33, which are configured to receive a screw that may be threaded through threads 31, 32, and 33. In some embodiments, threads (not shown) may also be formed at the sides of head portions 70 where the screw may engage after being threaded through threads 31, 32, and 33. In some embodiments, the additional threads on the sides of head portions 70 are configured to provide additional torque tolerance for the screw. It should be noted that, in alternative embodiments, a different number of platforms and/or threads may be formed, such as one, two, four, etc.

In some embodiments, the rotational orientation of all the treads may be determined based at least upon the distances between the platforms and the distance between the platforms (and optionally the sides of head portions 70) in order for a screw with appropriate threads to be able to be screwed through threads 31, 32, and 33 (and optionally through the threads of the sides of head portions 70) without binding.

In some embodiments, fastener clip 1100 may also include feet 20. Feet 20 are configured to rest against a first component to which fastener clip engages, providing a stopping point for fastener clip 1100.

In some embodiments, fastener clip 1100 may be made of metal, for strength and elasticity, for example. In some embodiments, fastener clip 1100 may be made from one continuous piece of a flat piece of metal that is appropriately punched, stamped, and/or bent to form the structures and features of fastener clip 1100. In some embodiments, the piece of metal may initially have an “L”, a “T”, or a “cross” shape, such that different components/structures of fastener clip 1100 may be formed from portions of the metal that were perpendicular to each other. For example, the platforms and threads may be formed by appropriately bending a first portion of the metal, and the wings, bumps, and head portions may be formed by appropriately bending a second portion of the metal that is perpendicular to the first portion.

In some embodiments, any number of platforms (and corresponding threads for each platform) may be formed depending on the torque requirements for screw 1200 in different applications. For example, each platform/thread contributes to the amount of torque that the screw can tolerate when coupling the second component to the first component, and as such, a greater number of platforms/threads may be chosen for higher torque requirements. In some embodiments, only two (or even one) platforms/threads may be used if less torque tolerance is required. And in embodiments where more torque tolerance is required, three or more platforms/threads may be used.

In some embodiments, supporting structures (such as connecting tabs, bumps, etc.) may be added as needed to better support the platforms. Additional support may be needed, for example, to handle the additional forces generated between the platforms/threads when a screw is inserted through threads 31, 32, and 33. Tabs, for example, may be formed and may be configured to engage corresponding receiving slots in the wings and/or platforms, thereby increasing the force required to move the platforms relative to each other and thus increasing the forces that each of the threads may withstand when a screw is inserted and tightened onto fastener clip 1100. In some embodiments, for additional support, support bumps may be formed and may be placed on the platforms and/or the threads in order to support the platforms/threads and to prevent the distance between them from being changed under the tension from inserting and tightening a screw into fastener clip 1100. In some embodiments, extension 50 may serve as stop to prevent the relative motion of platform 23 under tension by resting, under tension, against second component 1600, and thereby, further increasing the torque tolerance of screw 1200.

In some embodiments, pair of head portions 70 (and therefore, pair of wings 60 as well as bumps 75) are configured to be pushed apart by screw 1200 as screw 1200 is threaded through fastener clip 1100. In some embodiments, the force with which bumps 75 are pushing against the slot of first component 1500 (and therefore, the force required to forcibly remove faster clip 1100 from the slot of first component 1500) significantly increases. In some embodiments, the original distance between head portions 70 is configured to be less than the diameter of the screw in order for the screw to push head portions 70 apart to create the additional coupling force for fastener clip 1100.

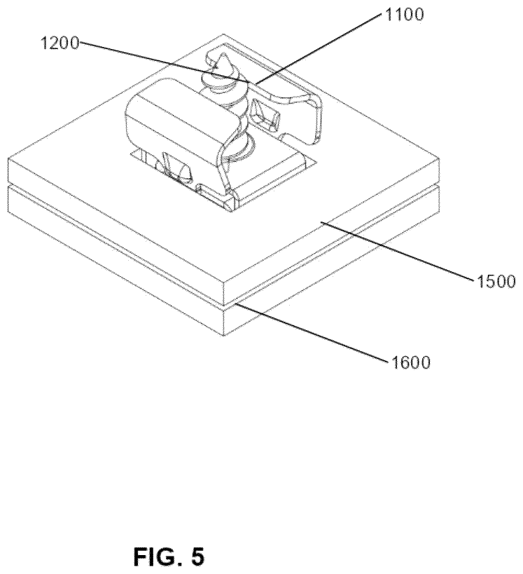

FIG. 5 is a view of an assembled fastener clip attached to a first component and to a screw and a second component, in accordance with some embodiments.

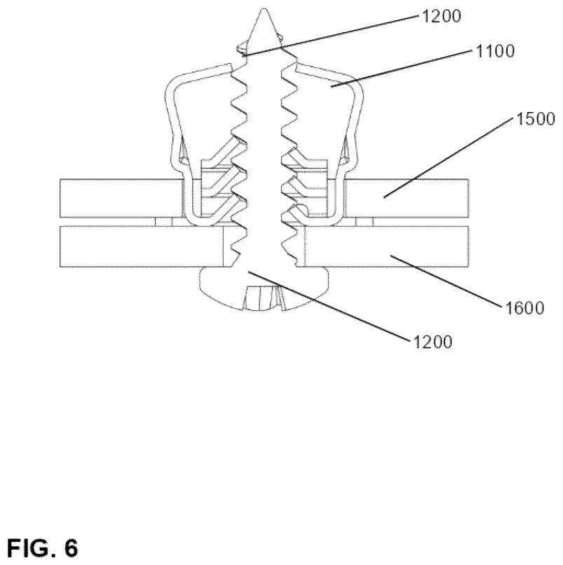

FIG. 6 is another view an assembled fastener clip attached to a first component and to a screw and a second component, in accordance with some embodiments.

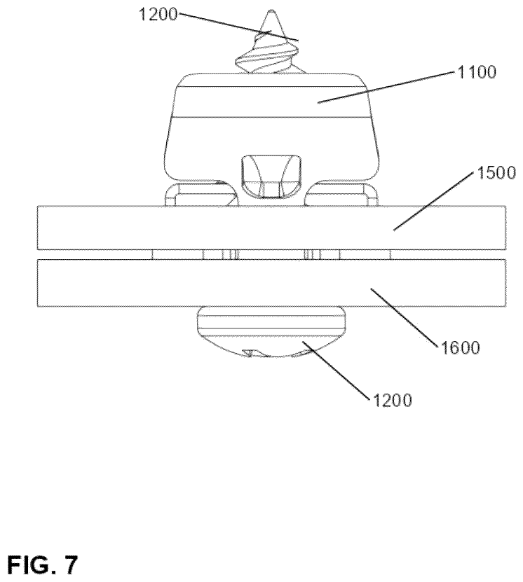

FIG. 7 is yet another view an assembled fastener clip attached to a first component and to a screw and a second component, in accordance with some embodiments.

In some embodiments, fastener clip 1100 may be configured to be attached to a slot in chassis 1500. Fastener clip 1100 is also configured to receive and couple to screw 1200. Screw 1200 may be used to attach various components, such as second component 1600, to chassis 1500.

It should be noted that, after being screwed into fastener clip 1100, screw 1200 is configured to push against the legs of fastener clip 1100 and to prevent the legs from collapsing inward. As such, this further increases the difficulty of separating fastener clip 1100 from chassis 1500, which further increases the coupling between the two.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

One or more embodiments of the invention are described above. It should be noted that these and any other embodiments are exemplary and are intended to be illustrative of the invention rather than limiting. While the invention is widely applicable to various types of systems, a skilled person will recognize that it is impossible to include all of the possible embodiments and contexts of the invention in this disclosure. Upon reading this disclosure, many alternative embodiments of the present invention will be apparent to persons of ordinary skill in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations that follow those terms. Accordingly, a system, method, or other embodiment that comprises a set of elements is not limited to only those elements and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A fastener clip assembly comprising:
a first wing and a second wing opposite the first wing, wherein the first wing and the second wing are configured to couple the fastener clip assembly to a slot in a first component based at least on the first wing and the second wing being configured to generate a force against the slot in the first component;
a screw;
two or more platforms between the first wing and the second wing, wherein at least two of the two or more platforms comprise at least two corresponding threads, wherein each of the threads is configured to receive the screw, wherein:
the screw is configured to couple a second component to the fastener clip assembly based at least on the screw being configured to be threaded into the threads of the platforms,
the first wing and the second wing are configured to increase the force based at least on the screw being configured to push apart the first wing and the second wing based at least on the screw being configured to be threaded into the threads of the platforms.

2. The fastener clip assembly of claim 1, further comprising a first bump on the first wing and a second bump on the second wing, wherein the first bump and the first wing and the second bump and the second wing are configured to couple the fastener clip to a slot in a first component based at least on the first bump and the second bump being configured to be inserted passed and against the slot in the first component.

3. The fastener clip assembly of claim 1, further comprising a first head portion extending from the first wing and a second head portion extending from the second wing, wherein the first wing and the second wing are configured to increase the force based at least on the screw being configured to push apart the first head portion and the second head portion based at least on the screw being configured to be threaded into the threads of the platforms.

4. The fastener clip assembly of claim 3, wherein a distance between the first head portion and the second head portion is less than a diameter of the screw.

5. The fastener clip assembly of claim 1, wherein the screw is configured to couple the second component to the first component based at least on the screw being configured to be inserted through a hole in the second component and to be threaded through the threads.

6. The fastener clip assembly of claim 1, wherein a number of the threads is determined based at least on the screw's torque requirements.

7. The fastener clip assembly of claim 1, wherein a rotational orientation of each the threads is determined based at least on vertical distances between the threads.

8. The fastener clip assembly of claim 1, wherein the two or more platforms are parallel to each other.

9. The fastener clip assembly of claim 1, further comprising feet that provide a stop as the fastener clip is being pushed into the slot in the first component.

10. The fastener clip assembly of claim 1, further comprising threads on the first head portion and the second head portion, wherein the screw is configured to be threaded through the first head portion and the second head portion.

11. The fastener clip assembly of claim 1, wherein the first leg, the second leg, and the two or more platforms are formed from a single and continuous piece of material.

12. The fastener clip assembly of claim 10, wherein the material is a flat metal piece that is bent, punched, or stamped to form the first wing, the second wing, the two or more platforms, and the threads.

13. The fastener clip assembly of claim 12, wherein the legs are made from folding perpendicularly to folding that forms the platforms.
